(19) United States
(12) Patent Application Publication
(10) Pub. No.: US 2013/0236166 A1
(43) Pub. Date: Sep. 12, 2013

(54) WATERPROOF CASE FOR CAMERA AND WATERPROOF STRUCTURE FOR CAMERA USING THE WATERPROOF CASE

(71) Applicant: SANYO ELECTRIC CO., LTD., Osaka (JP)

(72) Inventors: Yukio Enomoto, Daito-shi (JP); Hiromasa Yamagishi, Ikoma-shi (JP)

(73) Assignee: SANYO ELECTRIC CO., LTD., Osaka (JP)

(21) Appl. No.: 13/782,097

(22) Filed: Mar. 1, 2013

(30) Foreign Application Priority Data
Mar. 8, 2012 (JP) 2012-051862

(51) Int. Cl. G03B 17/08

(52) U.S. Cl. CPC G03B 17/08
USPC 396/25

(57) ABSTRACT

In a waterproof case for a camera, a case body which accommodates a lens barrel includes a fixed cylindrical member detachably attached to a camera body, a rotating cylindrical member relatively rotatably connected to a front opening of the fixed cylindrical member, and a movable cylindrical member which is accommodated in the rotating cylindrical member and which can reciprocate. A first seal is provided on a bonding portion of the fixed cylindrical member and the camera body, a second seal is provided on a bonding portion of the fixed cylindrical member and the rotating cylindrical member, and a third seal is provided on a bonding portion between the rotating cylindrical member and the movable cylindrical member. An engaging surface which contacts with an outer surface of the zoom ring of the lens barrel is provided on an inner surface of the rotating cylindrical member.

### CROSS-REFERENCE TO RELATED APPLICATIONS

The present application claims priority to Japanese Patent Application No. 2012-051862. The entirety of Japanese Patent Application No. 2012-051862 is incorporated by reference herein.

### BACKGROUND OF THE INVENTION

1. Field of the Invention

The present invention relates to a waterproof structure for a camera in which a lens barrel is detachably attached to a camera body, such as a camera including a retractable lens barrel, a single-lens reflex camera and a mirrorless interchangeable lens camera.

2. Description of Related Art

To realize waterproof or dripproof (hereinafter “waterproof”) of the camera, it is conventionally proposed to waterproof a casing configuring a camera body and a lens barrel.

However, in such a camera, although shooting is carried out while exchanging a plurality of lens barrels in accordance with a shooting scene, it is necessary to use special lens barrels having waterproof structures as the plurality of lens barrels, and there is a problem that general versatility of the lens barrels is poor.

Hence, it has been proposed to waterproof a camera by a rubber waterproof case accommodating the entire camera in which a lens barrel is detachably attached to a camera body. According to such a waterproof case, even if a camera includes a general lens barrel having no waterproof structure, it is possible to waterproof the camera.

However, according to the waterproof structure for a camera using the rubber waterproof case, since an outer shape and a size of the camera body differ depending upon a camera model, it is necessary to prepare a waterproof case having different outer shape and size for every camera model. Further, in the case of a camera in which a lens barrel is detachable and a zoom adjustment operation is carried out by rotating a zoom ring, it is difficult to rotate and operate the zoom ring through the waterproof case, and there is a problem that usage is limited to a camera in which a camera body is provided with a zoom operation key.

Hence, it is an object of the present invention to provide a waterproof structure for a camera in which it is possible to waterproof a camera including a general lens barrel having no waterproof structure and in which a zoom ring of the lens barrel can easily be rotated and operated.

### SUMMARY OF THE INVENTION

A waterproof case for a camera according to the present invention is used for a camera in which a lens barrel including a zoom ring for a zoom operation is detachably attached to a camera body.

The waterproof case includes a cylindrical case body in which the lens barrel attached to the camera body can be accommodated, the case body includes a fixed cylindrical member which is detachably attached to the camera body, a rotating cylindrical member which is relatively rotatably connected to a front opening of the fixed cylindrical member coaxially with the fixed cylindrical member, and a movable cylindrical member which is accommodated in the rotating cylindrical member and which is disposed such that the movable cylindrical member can reciprocate along a cylindrical shaft of the rotating cylindrical member, and a transparent plate closes a front opening of the movable cylindrical member.

An annular first seal portion surrounding the cylindrical shaft of the case body is provided on a bonding portion of the fixed cylindrical member with respect to the camera body, an annular second seal portion surrounding the cylindrical shaft of the case body is provided on a bonding portion of the fixed cylindrical member with respect to the rotating cylindrical member, and an annular third seal portion surrounding the cylindrical shaft of the case body is provided on a bonding portion between the rotating cylindrical member and the movable cylindrical member.

An engaging surface which comes into contact with an outer peripheral surface of the zoom ring of the lens barrel and rotates the zoom ring integrally with the rotating cylindrical member is provided on an inner peripheral surface of the rotating cylindrical member.

A converting mechanism which converts rotation of the rotating cylindrical member into a reciprocating movement of the movable cylindrical member is interposed between the rotating cylindrical member and the movable cylindrical member.

### BRIEF DESCRIPTION OF THE DRAWINGS

FIG. 1 is a perspective view showing a retracted state of a waterproof case in an embodiment of a camera according to the present invention;

FIG. 2 is a perspective view showing a projected state of the waterproof case in the camera;

FIG. 3 is a perspective view showing an unlocked state of the waterproof case in the camera;

FIG. 4 is a perspective view showing a state where a waterproof case is detached from the camera;

FIG. 5 is a perspective view of a camera body to which a lens barrel is attached;

FIG. 6 is a perspective view showing a state where the lens barrel is detached from the camera body;

FIG. 7 is a vertical sectional view of the camera in the retracted state of the waterproof case;

FIG. 8 is a vertical sectional view of the camera in the projected state of the waterproof case;

FIG. 9 is a diagram showing a cam groove formed in a rotating cylindrical member of the waterproof case;

FIG. 10 is a diagram showing a process in which a cam follower of a movable cylindrical member relatively moves along a cam groove of a rotating cylindrical member of the waterproof case;

FIG. 11 is an exploded perspective view showing a configuration of a rear side of the waterproof case;

FIG. 12 is an exploded perspective view showing a configuration of a front side of the waterproof case;

FIG. 13 is an enlarged sectional view of a first seal portion;

FIG. 14 is an enlarged sectional view of a second seal portion;

FIG. 15 is an enlarged sectional view of a third seal portion;

FIG. 16 is a horizontal sectional view showing a connecting portion between a camera body, a lens barrel and the waterproof case;

FIG. 17 is an enlarged sectional view of a locking/unlocking mechanism;

FIG. 18 is a perspective view showing a locking/unlocking mechanism provided in a cabinet front portion of the camera body;

FIG. 19 is an exploded perspective view of the locking and unlocking mechanism and a lens barrel bonding portion of the camera body as viewed from a rear surface side of the cabinet front portion;

FIG. 20 is an exploded perspective view of the locking and unlocking mechanism as viewed from a front surface side of the cabinet front portion; and

FIG. 21 is an exploded perspective view of the lens barrel bonding portion of the camera body as viewed from the front surface side of the cabinet front portion.

### DETAILED DESCRIPTION OF THE PREFERRED EMBODIMENT

An embodiment in which the present invention is applied to a digital camera will be described specifically along the drawings. In the following description, a shooting direction of the digital camera is called front or forward and an opposite direction is called rear, back or rearward. A term “waterproof” includes a conception of “dripproof”.

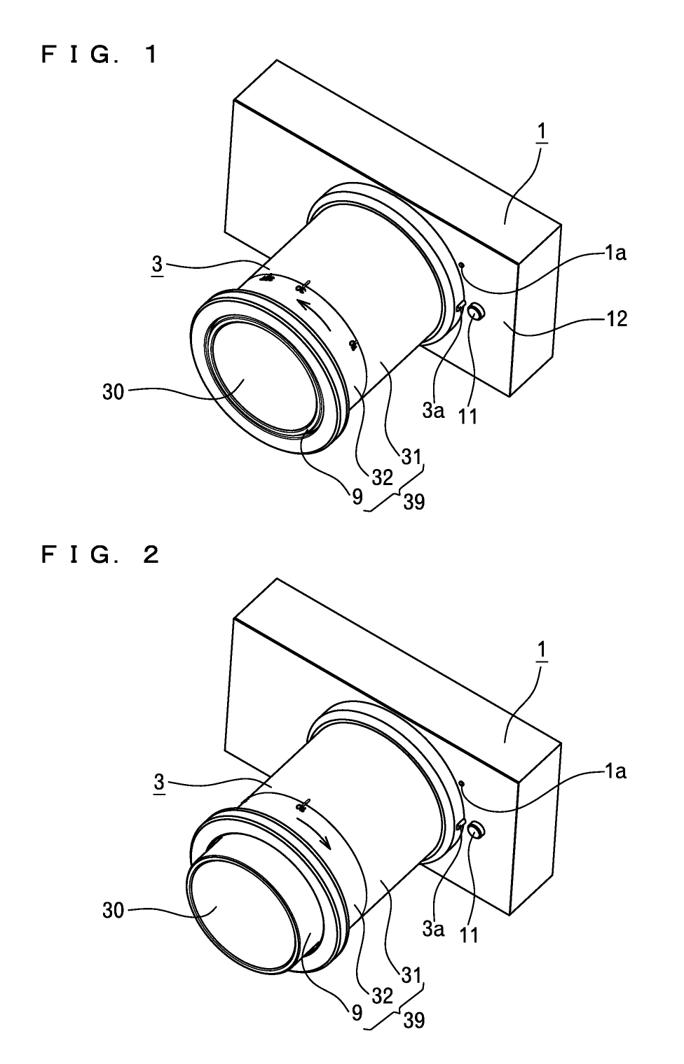

As shown in FIGS. 5 and 6, a digital camera which is an embodiment of the present invention includes a camera body 1 and a lens barrel 2 detachably attached to a cabinet front portion 12 of the camera body 1. As shown in FIGS. 1 to 4, the digital camera also includes a waterproof case 3 which is detachably attached to the cabinet front portion 12 of the camera body 1 and in which the lens barrel 2 is accommodated.

As shown in FIG. 6, a shooting window 16 through which a light beam from the lens barrel 2 is taken into the camera body 1 opens at the cabinet front portion 12 of the camera body 1. A lens barrel fixing ring 5 which surrounds the shooting window 16 to attach the lens barrel 2, and a case fixing ring 6 for attaching the waterproof case 3 are disposed on the cabinet front portion 12.

An unlocking button 11 which is operated when detaching the lens barrel 2 and the waterproof case 3 from the camera body 1 is disposed on the cabinet front portion 12 of the camera body 1.

A casing configuring the camera body 1 (excluding shooting window 16) has a waterproof structure. Known structures which are conventionally used for casings of various kinds of electronic devices can be employed as the waterproof structure.

The lens barrel 2 includes a fixed lens barrel portion 21 which is to be detachably attached to the lens barrel fixing ring 5 of the camera body 1, a movable lens barrel portion 22 which is disposed coaxially with the fixed lens barrel portion 21 and which can reciprocate along a cylindrical shaft of the fixed lens barrel portion 21, and a zoom ring 23 which is rotatably disposed coaxially with the fixed lens barrel portion 21. The movable lens barrel portion 22 reciprocates in the longitudinal direction in connection with rotation of the zoom ring 23. The smallest zoom ratio is set at a position (W end) where the movable lens barrel portion 22 most retracts, and the greatest zoom ratio is set at a position (T end) where the movable lens barrel portion 22 most advances.

An outer peripheral surface of the zoom ring 23 is formed of cylindrical resilient member so that the zoom ring 23 can easily be rotated and operated by friction resistance caused when a finger is put on the outer peripheral surface.

An O-ring 42 shown in FIG. 13 is fitted into a recess formed in an opposed surface of the fixed lens barrel portion 21 which is opposed to the camera body 1.

In the lens barrel 2, if the zoom ring 23 is rotated and the movable lens barrel portion 22 is made to reciprocate in the longitudinal direction, a zoom adjustment can be carried out.

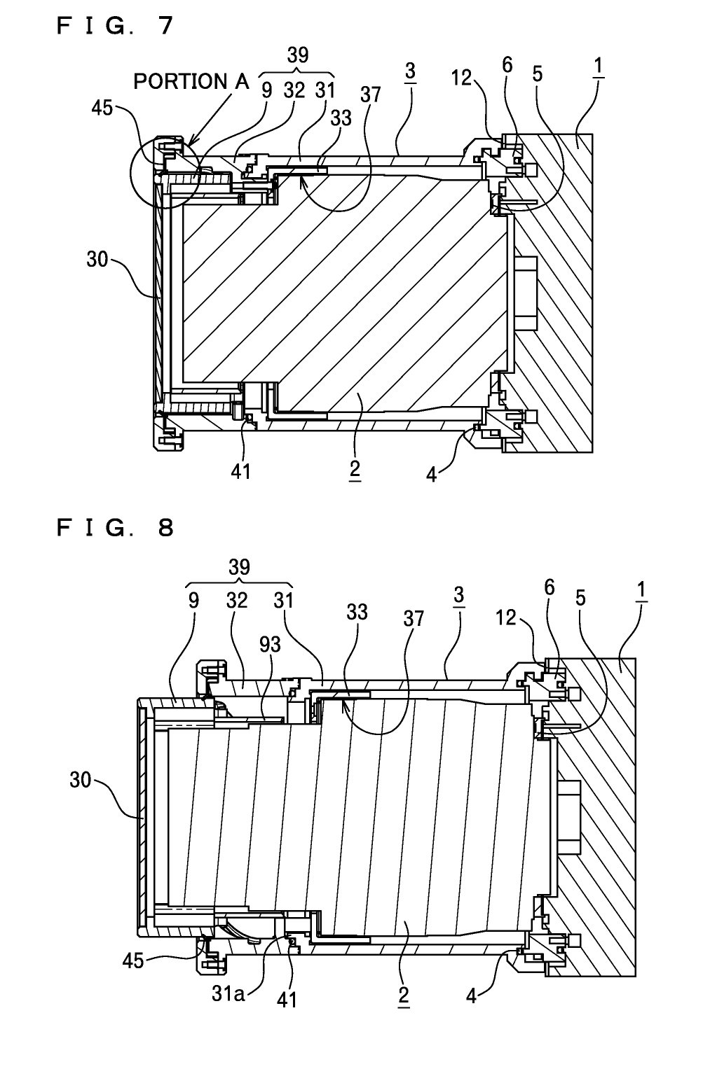

As shown in FIGS. 7 and 8, the waterproof case 3 includes a cylindrical case body 39 in which the lens barrel 2 attached to the camera body 1 can be accommodated. The case body 39 is made of synthetic resin. The case body 39 includes a fixed cylindrical member 31 which can detachably be attached to the camera body 1, a rotating cylindrical member 32 which is relatively rotatably connected an open end of the fixed cylindrical member 31 coaxially with the fixed cylindrical member 31, and a movable cylindrical member 9 which is accommodated in the rotating cylindrical member 32 and which can reciprocate along the cylindrical shaft of the rotating cylindrical member 32. A transparent plate 30 is adhered and fixed to a front open end of the movable cylindrical member 9.

If the rotating cylindrical member 32 of the waterproof case 3 is rotated, the movable cylindrical member 9 reciprocates in the longitudinal direction.

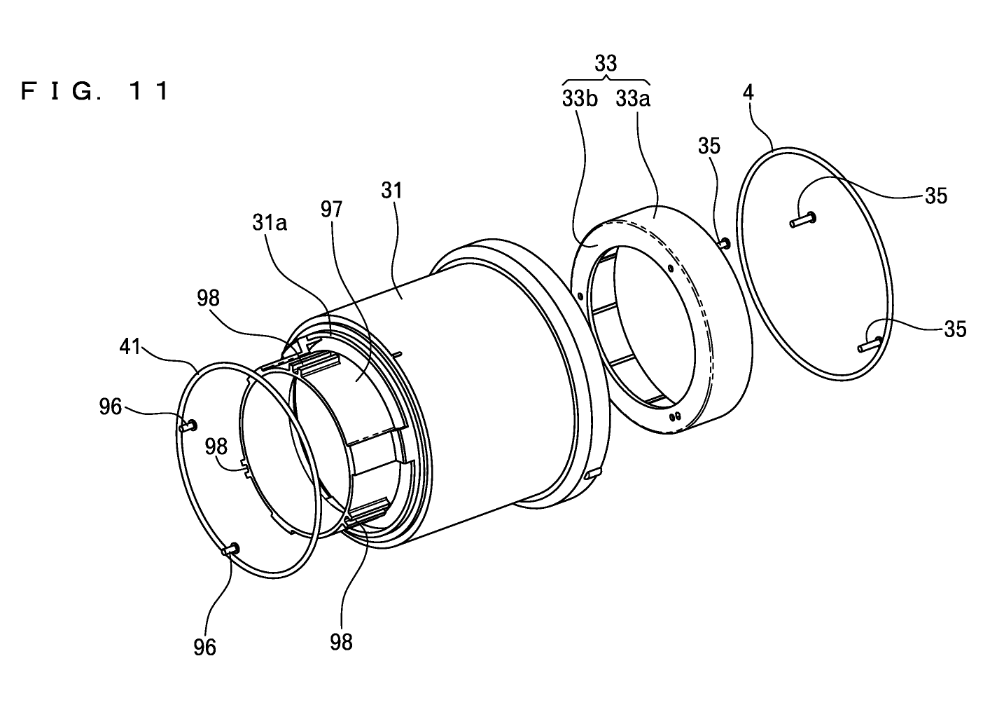

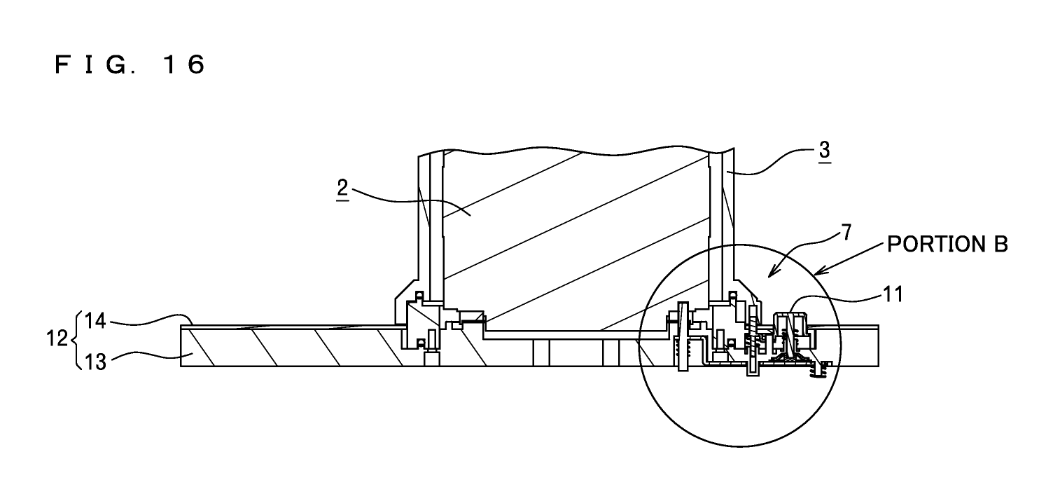

As shown in FIGS. 11 and 14, a ring member 33 made of synthetic resin is fitted into the fixed cylindrical member 31 configuring the waterproof case 3. The ring member 33 includes a cylindrical portion 33a and a disk portion 33b. The ring member 33 is fastened to the rotating cylindrical member 32 by screwing three screws 35 from the disk portion 33b into bosses 34 of the rotating cylindrical member 32.

As shown in FIG. 14, a front end portion 31a of the fixed cylindrical member 31 is sandwiched between a rear end of the rotating cylindrical member 32 and the ring member 33 under pressure. According to this configuration, the fixed cylindrical member 31 and the rotating cylindrical member 32 are relatively rotatably and coaxially connected to each other.

A cylindrical surface-shaped engaging surface 37 which should be brought into contact, under pressure, with an outer peripheral surface 26 of the zoom ring 23 of the lens barrel 2 is formed on an inner peripheral surface of the cylindrical portion 33a of the ring member 33. The outer peripheral surface 26 of the zoom ring 23 and the engaging surface 37 of the ring member 33 are formed into tapered surfaces whose diameters are slightly reduced forwardly. An outer diameter of the outer peripheral surface 26 of the zoom ring 23 is slightly greater than an inner diameter of the engaging surface 37 of the ring member 33.

A plurality of protruding portions (not shown) extending in the cylindrical shaft direction of the ring member 33 is formed on the engaging surface 37 of the ring member 33. The outer peripheral surface 26 of the zoom ring 23 is slightly resiliently deformed by bringing the engaging surface 37 into contact with the outer peripheral surface 26 of the zoom ring 23 under pressure. The outer peripheral surface 26 of the zoom ring 23 and the engaging surface 37 of the ring member 33 are in contact with each other under pressure while creating friction resistance. As the rotating cylindrical member 32 rotates, the zoom ring 23 can integrally rotate.

An O-ring 41 extending to surround a front end portion 31a of the fixed cylindrical member 31 is provided on a bonding portion between the fixed cylindrical member 31 and the rotating cylindrical member 32 of the waterproof case 3. The O-ring 41 is sandwiched between the fixed cylindrical member 31 and the rotating cylindrical member 32 under pressure. The O-ring 41 configures a seal portion (second seal portion) which waterproofs between the fixed cylindrical member 31 and the rotating cylindrical member 32.

While the rotating cylindrical member 32 rotates with respect to the fixed cylindrical member 31, the O-ring 41 slides on any of cylindrical members, and allows the rotating cylindrical member 32 to rotate while keeping the waterproof ability.

The fixed cylindrical member 31 configures the waterproof case 3. As shown in FIGS. 11 and 13, an O-ring 4 extending to surround the cylindrical shaft of the fixed cylindrical member 31 is fitted into an annular recess portion 31b formed in a surface of the fixed cylindrical member 31 which is opposed to the camera body 1.

As shown in FIG. 11, a cylindrical portion 97 having a diameter which is slightly smaller than that of the front end portion 31a projects from a front end portion 31a of the fixed cylindrical member 31. Three guide grooves 98, 98, 98 extending in the direction of the cylindrical shaft are formed in an outer peripheral surface of the cylindrical portion 97 at 120° phase intervals from one another.

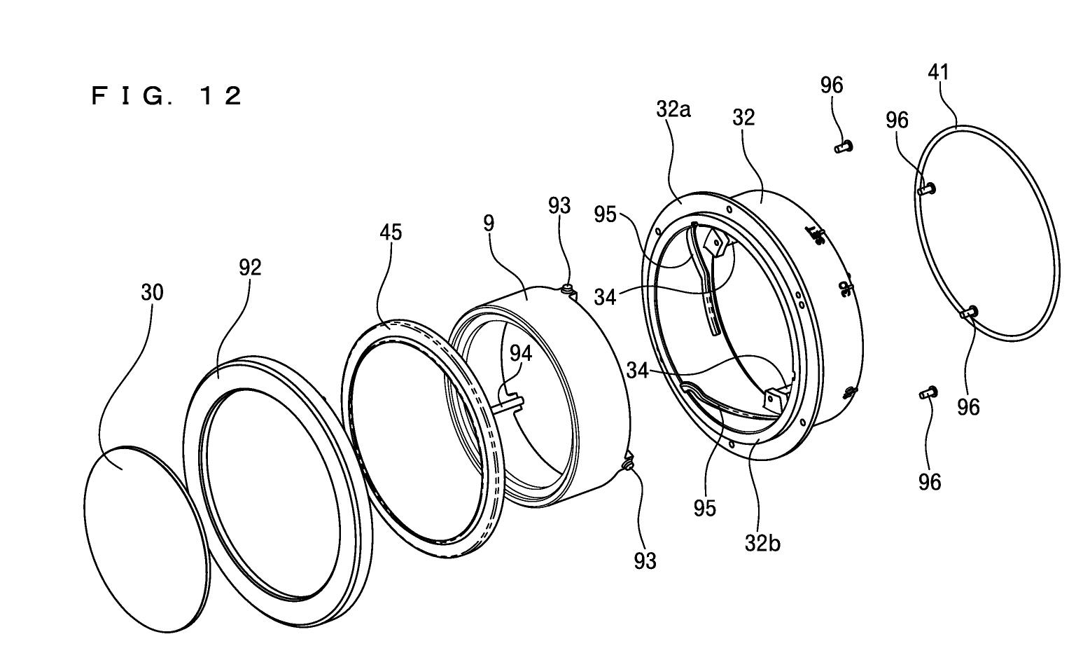

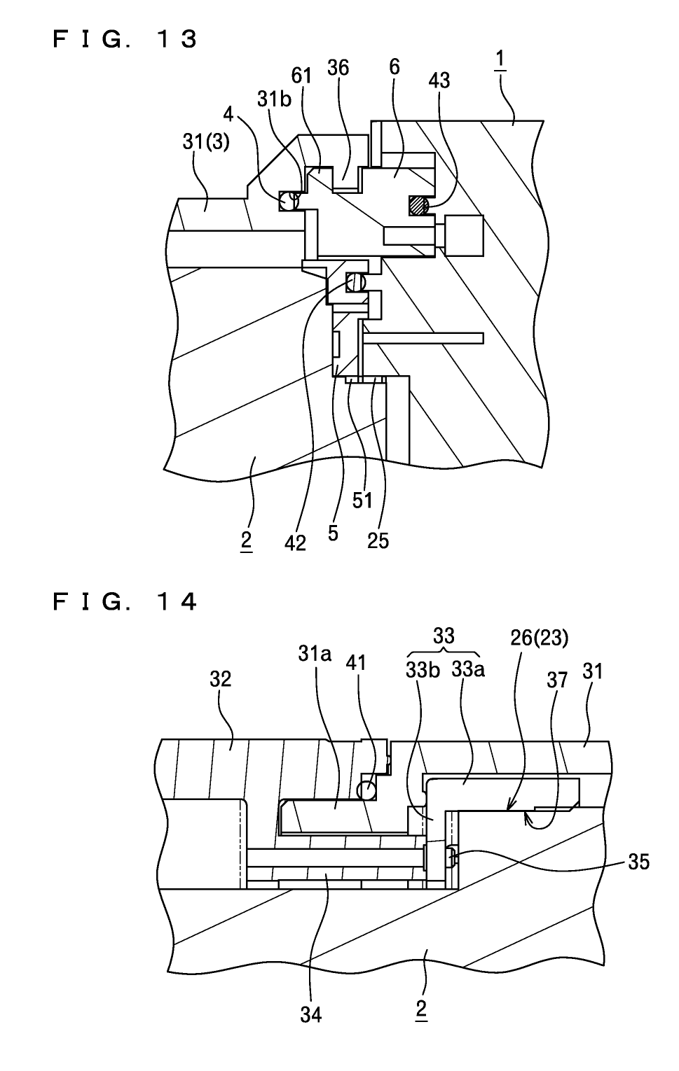

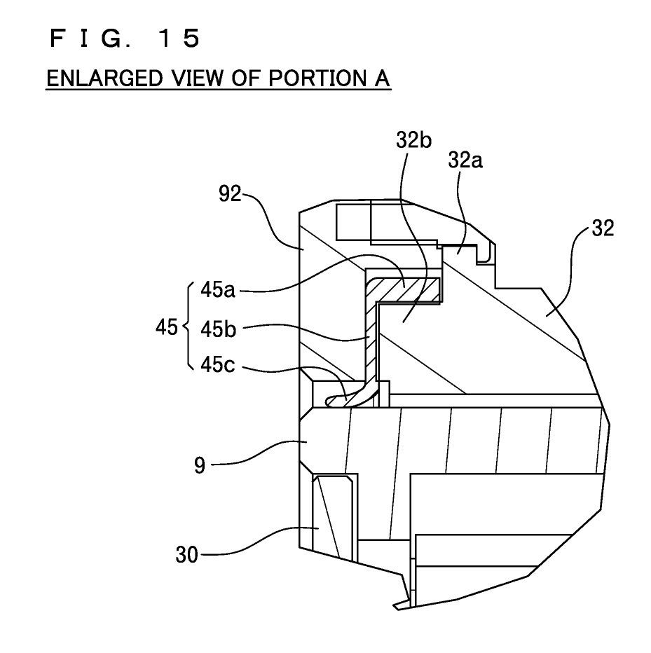

As shown in FIG. 12, the rotating cylindrical member 32 has an inner diameter which is slightly greater than an outer diameter of the cylindrical portion 97 of the fixed cylindrical member 31, and has an outer diameter which is equal to that of the fixed cylindrical member 31. Three cam grooves 95, 95, 95 spirally extending around the cylindrical shaft are formed in the inner peripheral surface of the rotating cylindrical member 32 at 120° intervals from one another.

The movable cylindrical member 9 has an outer diameter which is slightly smaller than an inner diameter of the rotating cylindrical member 32. The movable cylindrical member 9 is accommodated in the rotating cylindrical member 32 such that the movable cylindrical member 9 can rotate and reciprocate. Three cam followers 93, 93, 93 which outwardly and radially project are formed on a rear end edge of an outer peripheral surface of the movable cylindrical member 9 at 120° phase intervals from one another. Three protrusions 94, 94, 94 extending in the direction of the cylindrical shaft are formed on an inner peripheral surface of the movable cylindrical member 9 at 120° phase intervals from one another.

The movable cylindrical member 9 has an inner diameter which is slightly greater than an outer diameter of the cylindrical portion 97 of the fixed cylindrical member 31.

The cam followers 93 of the movable cylindrical member 9 are slidably engaged with the cam grooves 95 of the rotating cylindrical member 32 in a state where the movable cylindrical member 9 is accommodated in the rotating cylindrical member 32.

The protrusions 94, 94, 94 of the movable cylindrical member 9 are slidably engaged with the guide grooves 98, 98, 98 of the cylindrical portion 97 of the fixed cylindrical member 31 in a state where the movable cylindrical member 9 is accommodated in the rotating cylindrical member 32 and the cylindrical portion 97 of the fixed cylindrical member 31 is accommodated in the movable cylindrical member 9.

Therefore, the movable cylindrical member 9 is connected to the fixed cylindrical member 31 such that the movable cylindrical member 9 can not rotate and can reciprocate in the direction of the cylindrical shaft. The rotating cylindrical member 32 is connected to the fixed cylindrical member 31 such that the rotating cylindrical member 32 can not move in the direction of the cylindrical shaft and can rotate around the cylindrical shaft.

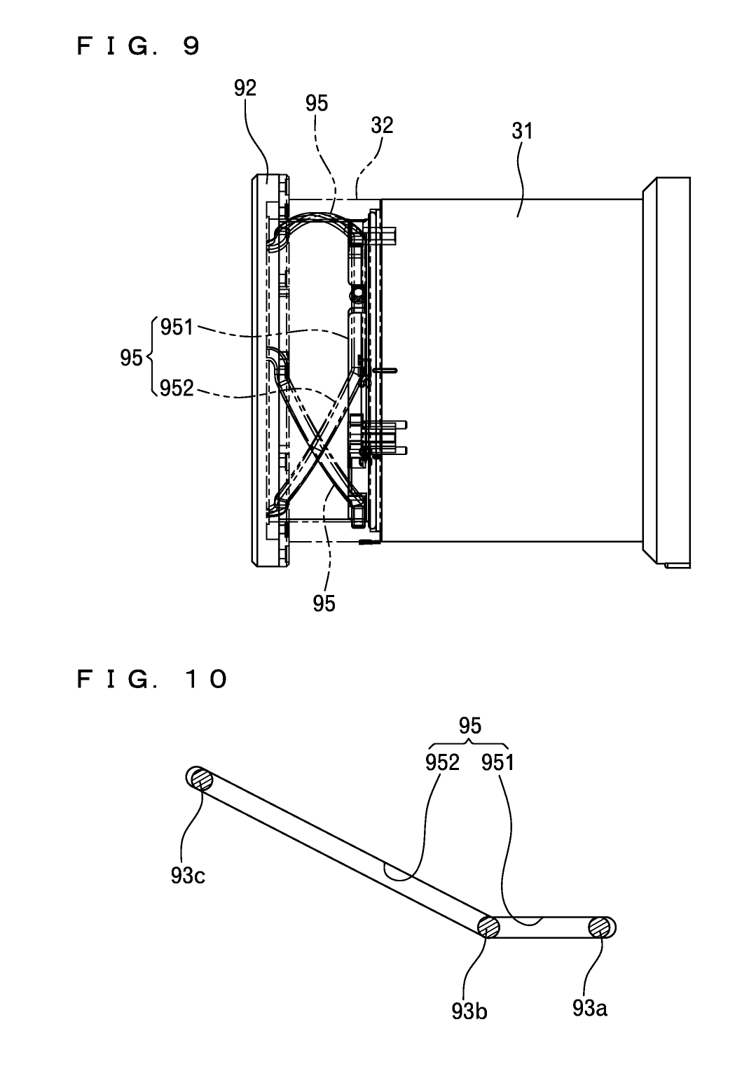

As shown in FIG. 9, each of the cam grooves 95 of the rotating cylindrical member 32 includes a horizontal portion 951 extending such that the cam groove 95 intersects with the cylindrical shaft of the fixed cylindrical member 31 at right angles, and an inclined portion 952 extending from one end edge of the horizontal portion 951 such that the inclined portion 952 inclines with respect to the cylindrical shaft.

As shown in FIG. 10, if the rotating cylindrical member 32 is rotated in a counterclockwise direction, the cam follower 93 moves from a start end position 93a of the horizontal portion 951 of the cam groove 95 to a terminal end position 93c of the inclined portion 952 through a boundary position 93b between the horizontal portion 951 and the inclined portion 952.

Here, the start end position 93a of the horizontal portion 951 of the cam groove 95 becomes a set position where the waterproof case 3 should be attached to the camera body 1, the boundary position 93b between the horizontal portion 951 and the inclined portion 952 becomes the position (W end) where the lens barrel 2 and the waterproof case 3 are most retracted and the smallest zoom ratio is set, and the terminal end position 93c of the inclined portion 952 becomes the position (T end) where the lens barrel 2 and the waterproof case 3 are most projected and the greatest zoom ratio is set.

As shown in FIG. 12, a front surface ring 92 is attached to a front end portion of the rotating cylindrical member 32 through a ring-shaped seal member 45, four screws 96 are screwed into the front surface ring 92 from the flange 32a of the rotating cylindrical member 32. According to this operation, the front surface ring 92 is fixed to the rotating cylindrical member 32, and a base end portion of the ring-shaped seal member 45 is sandwiched between the rotating cylindrical member 32 and the front surface ring 92 under pressure.

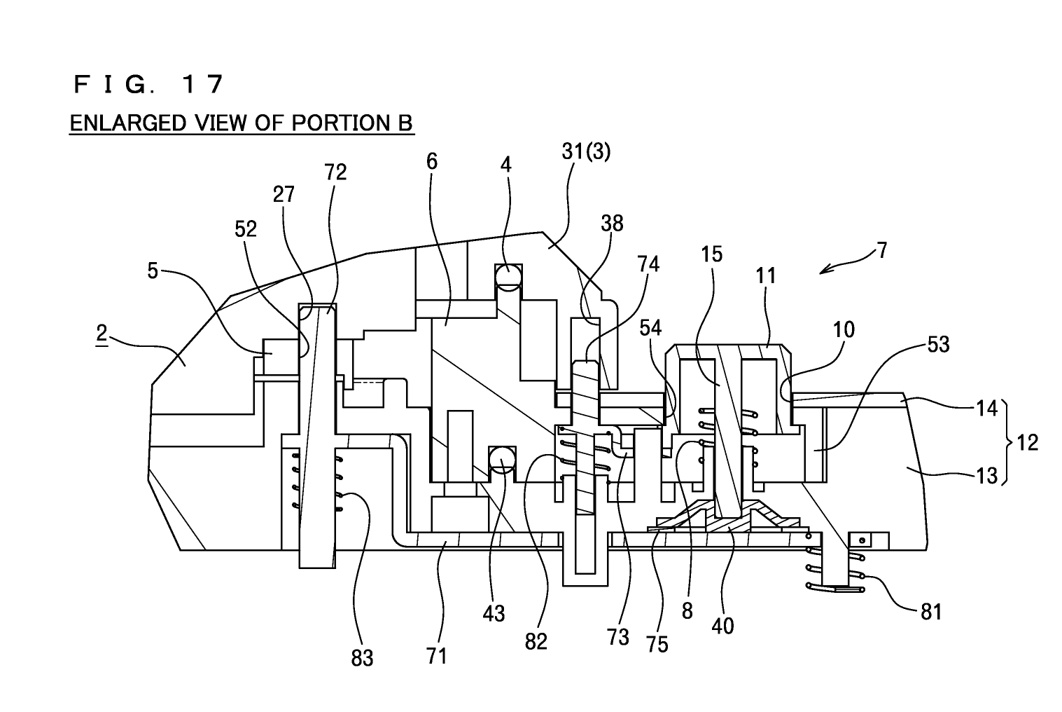

As shown in FIG. 15, the ring-shaped seal member 45 includes a cylindrical portion 45a covering an outer peripheral surface of the front end portion 32b of the rotating cylindrical member 32, a disk portion 45b extending in a form of a ring along an end surface of the front end portion 32b of the rotating cylindrical member 32, and a ring-shaped tongue portion 45c extending diagonally toward the outer peripheral surface of the movable cylindrical member 9. The disk portion 45b of the ring-shaped seal member 45 is sandwiched between the rotating cylindrical member 32 and the front surface ring 92, and a tip end of the tongue portion 45c is brought into contact with the outer peripheral surface of the movable cylindrical member 9 under pressure by a resilient repulsion force of the tip end.

Therefore, in the process in which the movable cylindrical member 9 reciprocates by rotation of the rotating cylindrical member 32, the tongue portion 45c of the ring-shaped seal member 45 is brought into contact with the outer peripheral surface of the movable cylindrical member 9 under pressure and in this state, the tongue portion 45c slides on the outer peripheral surface, and this blocks water entering the case body 39 from a gap between the front surface ring 92 and the movable cylindrical member 9.

A seal portion (third seal portion) is formed between the rotating cylindrical member 32 and the movable cylindrical member 9 by the ring-shaped seal member 45.

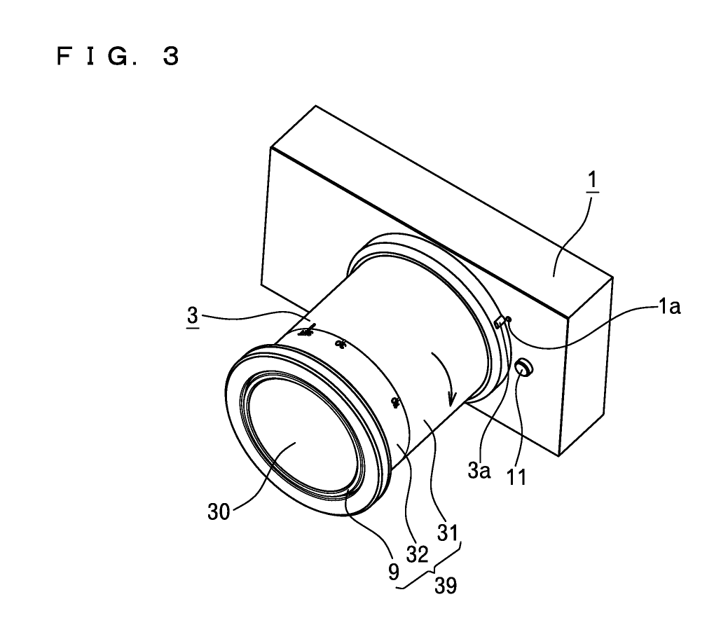

In the waterproof case 3, the cam grooves 95 of the rotating cylindrical member 32 extend such that the cam grooves 95 pivot forward from behind in the counterclockwise direction. Therefore, if the rotating cylindrical member 32 is rotated in the counterclockwise direction toward the camera body 1 as shown by an arrow in FIG. 1, the movable cylindrical member 9 moves forward as shown in FIG. 2, and if the rotating cylindrical member 32 is rotated in the clockwise direction toward the camera body 1 as shown by an arrow in FIG. 2, the movable cylindrical member 9 moves rearward as shown in FIG. 1.

In this manner, a cam mechanism which converts rotation of the rotating cylindrical member 32 into a reciprocating movement of the movable cylindrical member 9 is configured.

As shown in FIG. 6, three engaged ribs 51, 51, 51 extending on an arc at intervals of 120° phase angle from one another project on the lens barrel fixing ring 5. As shown in FIG. 13, three engaging ribs 25, 25, 25 extending on an arc project on the fixed lens barrel portion 21 of the lens barrel 2 at positions corresponding to the engaged ribs 51, 51, 51 of the lens barrel fixing ring 5.

The fixed lens barrel portion 21 of the lens barrel 2 is pressed against the lens barrel fixing ring 5 in a predetermined relative angle attitude and in this state, the fixed lens barrel portion 21 is rotated about 30° in the counterclockwise direction and screwed, and the engaging ribs 25 are engaged with the engaged ribs 51. According to this operation, the lens barrel 2 can detachably be attached to the camera body 1.

This configuration is the same as a configuration for detachably attaching the lens barrel in the conventional camera.

By attaching the lens barrel 2 to the camera body 1, the O-ring 42 disposed on the lens barrel 2 is sandwiched between the fixed lens barrel portion 21 of the lens barrel 2 and the camera body 1 under pressure, and the seal portion is configured between the lens barrel 2 and the camera body 1 by the O-ring 42.

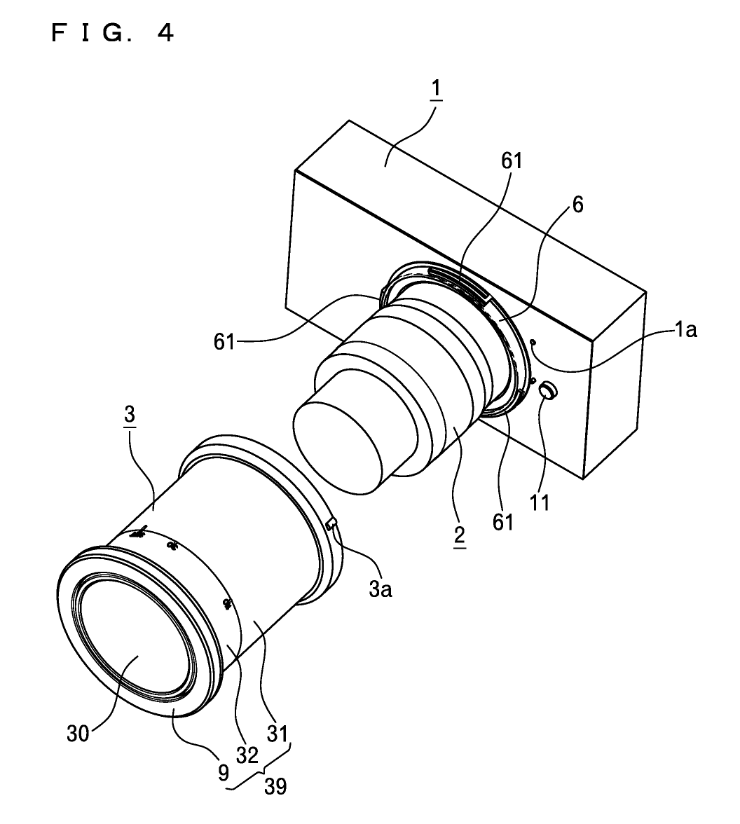

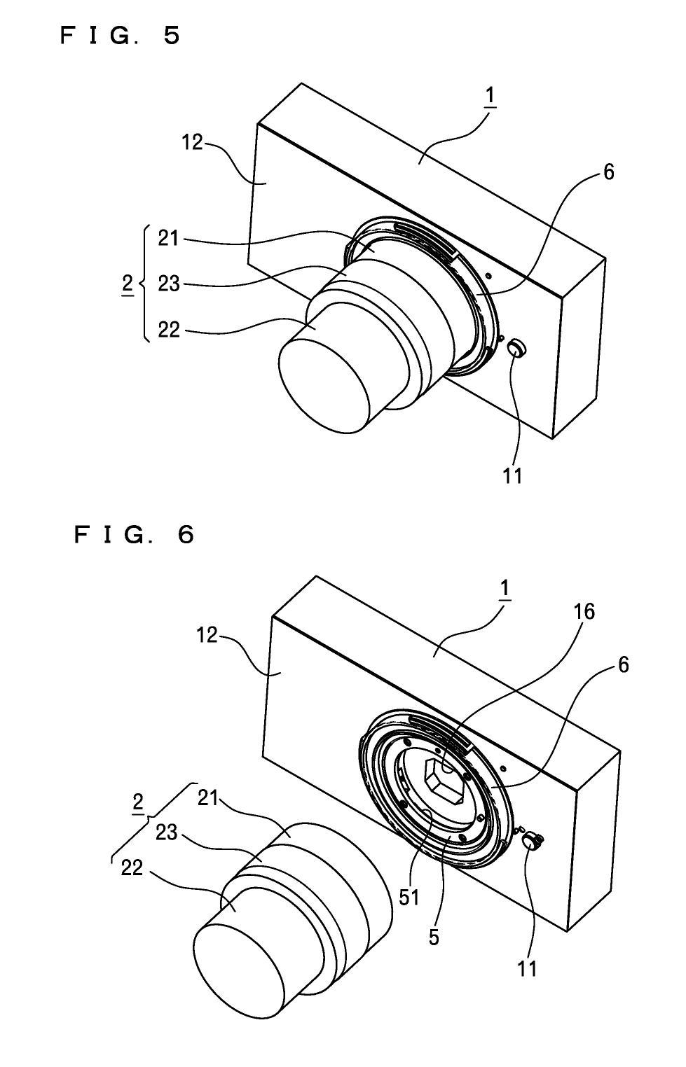

As shown in FIG. 4, three engaged ribs 61, 61, 61 extending on an arc at intervals of 120° phase angle from one another project on the case fixing ring 6. As show in FIG. 13, three engaging ribs 36, 36, 36 extending on an arc project on the fixed cylindrical member 31 of the waterproof case 3 at positions corresponding to the engaged ribs 61, 61, 61 of the case fixing ring 6.

As shown in FIGS. 3 and 4, in the relative angle attitude in which an index 1a provided on the camera body 1 and an index 3a provided on the waterproof case 3 match with each other, the fixed cylindrical member 31 of the waterproof case 3 is pressed against the case fixing ring 6 and in this state, the fixed cylindrical member 31 is rotated about 30° in the clockwise direction as shown by an arrow in FIG. 3 and screwed, and the engaging ribs 36 are engaged with the engaged ribs 61. According to this operation, the waterproof case 3 can detachably be attached to the camera body 1.

This configuration is the same as a configuration for detachably attaching the lens barrel 2 to the camera body 1.

By attaching the waterproof case 3 to the camera body 1, the O-ring 4 is sandwiched between the fixed cylindrical member 31 of the waterproof case 3 and the case fixing ring 6 under pressure, and a seal portion (first seal portion) is configured between the fixed cylindrical member 31 and the case fixing ring 6 by the O-ring 4.

An O-ring 43 is interposed between the camera body 1 and the case fixing ring 6, and a seal portion is configured between the camera body 1 and the case fixing ring 6 by the O-ring 43.

In the process in which the fixed cylindrical member 31 of the waterproof case 3 is rotated about 30° in the clockwise direction to attach the waterproof case 3 to the camera body 1 as shown by an allow in FIG. 3, the cam follower 93 of the movable cylindrical member 9 slides on the horizontal portion 951 of the cam groove 95 of the rotating cylindrical member 32. In this process, the movable cylindrical member 9 does not move irrespective of rotation of the rotating cylindrical member 32.

As the fixed cylindrical member 31 of the waterproof case 3 rotates in the clockwise direction, the rotating cylindrical member 32 also receives a clockwise rotation torque, but the rotating cylindrical member 32 is engaged with the zoom ring 23 of the lens barrel 2 such that the rotating cylindrical member 32 can rotate integrally with the zoom ring 23, and the zoom ring 23 can not rotate in the clockwise direction any more in the retracted state of the lens barrel 2. Therefore, the rotating cylindrical member 32 of the waterproof case 3 does not rotate in the clockwise direction.

Therefore, in the waterproof case 3, only the fixed cylindrical member 31 rotates in the clockwise direction in a state where the rotating cylindrical member 32 is prevented from rotating.

In this manner, the rotating cylindrical member 32 rotates about 30° in the counterclockwise direction relative to the fixed cylindrical member 31 in the process in which the waterproof case 3 is attached to the camera body 1 but as described above, the cam follower 93 of the movable cylindrical member 9 slides on the horizontal portion 951 of the cam groove 95 of the rotating cylindrical member 32, and the movable cylindrical member 9 does not move. Therefore, a relative position between the movable lens barrel portion 22 of the lens barrel 2 and the movable cylindrical member 9 of the waterproof case 3 is not changed.

Thereafter, the rotating cylindrical member 32 is further rotated in the counterclockwise direction. According to this operation, the cam follower 93 slides on the inclined portion 952 of the cam groove 95 and as the rotating cylindrical member 32 rotates, the movable cylindrical member 9 moves forward.

In a state where the cam follower 93 is in slide-contact with the inclined portion 952 of the cam groove 95, if the rotating cylindrical member 32 is rotated in the counterclockwise direction toward the camera body 1 as shown by the arrow in FIG. 1, the movable cylindrical member 9 moves forward as shown in FIG. 2 and in synchronism with this movement, the movable lens barrel portion 22 of the lens barrel 2 moves forward (see FIG. 8). If the rotating cylindrical member 32 is rotated in the clockwise direction toward the camera body 1 as shown by the arrow in FIG. 2, the movable cylindrical member 9 moves rearward in synchronism with this rotation as shown in FIG. 1 and in synchronism with this movement, the movable lens barrel portion 22 of the lens barrel 2 moves rearward (see FIG. 7).

The inclination angle of the inclined portion 952 of the cam groove 95 is determined such that a moving amount of the movable cylindrical member 9 caused by the rotation of the rotating cylindrical member 32 of the waterproof case 3 and a moving amount of the movable lens barrel portion 22 of the lens barrel 2 become equal to or substantially equal to each other.

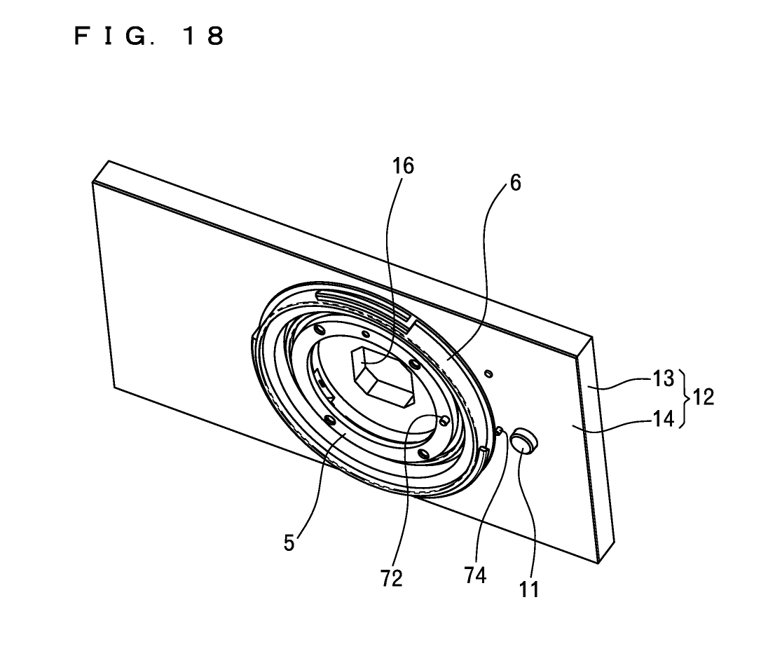

As shown in FIG. 16, a locking/unlocking mechanism 7 is disposed on a bonding portion between the cabinet front portion 12, the lens barrel 2 and the waterproof case 3. The locking/unlocking mechanism 7 locks the lens barrel 2 and the waterproof case 3 in their attached state, or unlocks the lens barrel 2 and the waterproof case 3.

As shown in FIGS. 17 to 21, the locking/unlocking mechanism 7 includes a lens barrel lock pin 72 which is disposed on a bonded surface of the lens barrel fixing ring 5 with respect to the lens barrel 2 such that the lens barrel lock pin 72 can project and retract and which is biased in a projecting direction by a spring 83, a case lock pin 74 which is disposed on a bonded surface of the case fixing ring 6 with respect to the waterproof case 3 such that the case lock pin 74 can project and retract and which is biased in a projecting direction by a spring 82, and a pin hole 27 which is formed in a bonded surface of the lens barrel 2 with respect to the lens barrel fixing ring 5 and into which a tip end of the lens barrel lock pin 72 can be fitted, a pin hole 38 which is formed in a bonded surface of the waterproof case 3 with respect to the case fixing ring 6 and into which a tip end of the case lock pin 74 can be fitted, the unlocking button 11 which is disposed on the camera body 1 such that the unlocking button 11 can be pushed down and which is biased in a projecting direction by a spring 8, a first movable member 71 interposed between the unlocking button 11 and the lens barrel lock pin 72, and a second movable member 73 interposed between the unlocking button 11 and the case lock pin 74.

One end of the first movable member 71 is integrally connected to the lens barrel lock pin 72, and the other end of the first movable member 71 is opposed to a lower end surface of a shaft portion 15 of the unlocking button 11. The other end of the first movable member 71 is biased forward by a spring 81.

A disk packing 40 is interposed between a lower end of the shaft portion 15 of the unlocking button 11 and the other end of the first movable member 71. The packing 40 can resiliently be deformed in a compressing direction.

A washer piece 75 is disposed on the other end of the first movable member 71 on a surface on the side of the unlocking button 11, and the packing 40 is sandwiched between the shaft portion 15 of the unlocking button 11 and the washer piece 75 by biasing forces of the springs 83, 8 under pressure.

According to this configuration, the other end of the first movable member 71 presses the unlocking button 11 forward (in projecting direction).

One end of the second movable member 73 is integrally connected to the case lock pin 74, and the other end of the second movable member 73 is opposed to a lower end surface of an outer periphery of the unlocking button 11. The other end of the second movable member 73 is brought into contact, under pressure, with a lower end surface of the outer periphery of the unlocking button 11 by a biasing force of the spring 82.

According to this configuration, the other end of the second movable member 73 presses the unlocking button 11 forward (in projecting direction).

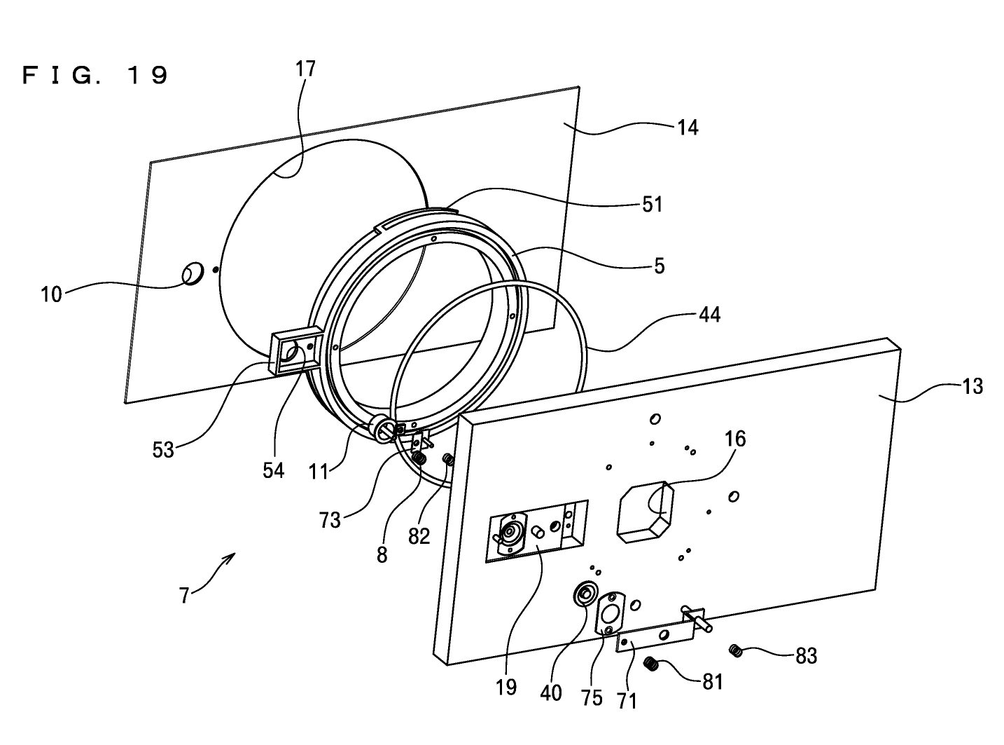

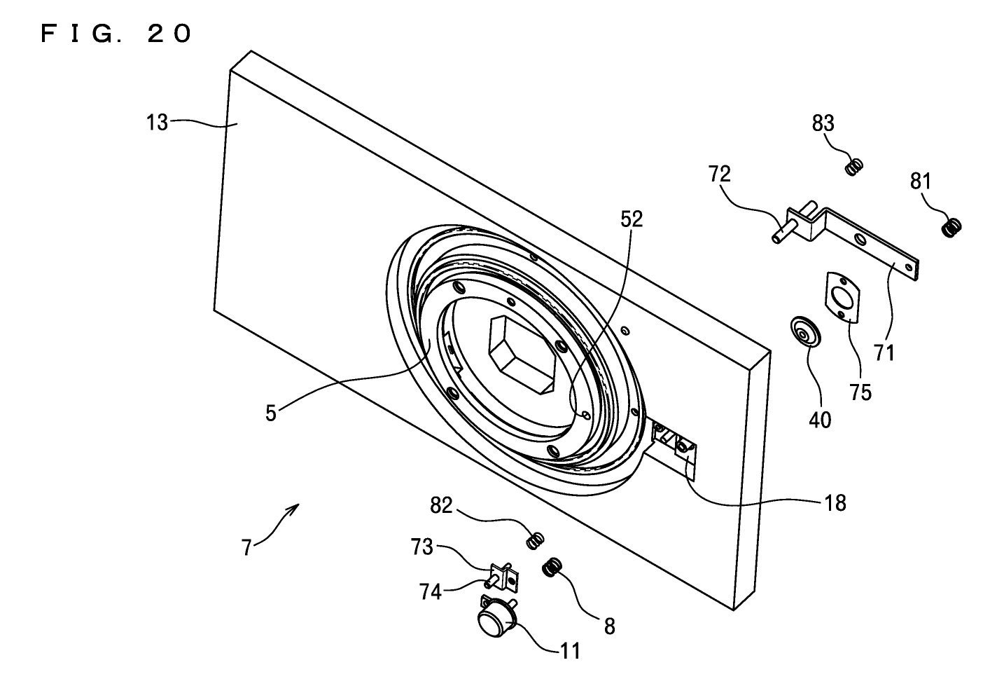

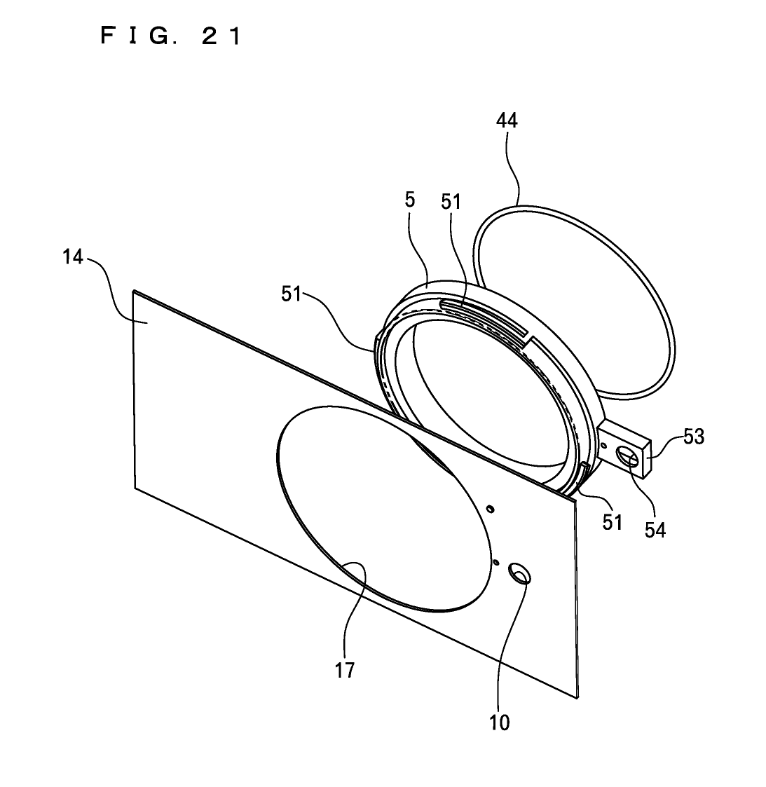

As shown in FIG. 18, the cabinet front portion 12 has a laminated structure including a first plate 13 and a second plate 14. As shown in FIG. 19, an attaching portion 19 for the packing 40, the washer piece 75, the first movable member 71 and the springs 81 and 83 is formed in a back surface of the first plate 13 in a recessed manner. As shown in FIG. 20, an attaching portion 18 for the springs 8 and 82, the second movable member 73 and the unlocking button 11 is formed in a front surface of the first plate 13 in a recessed manner.

As shown in FIGS. 19 and 21, a circular window 17 from which a front surface of the lens barrel fixing ring 5 is exposed and a circular hole 10 from which a head of the unlocking button 11 is exposed are formed in the second plate 14, and a circular hole 54 is formed in a holding piece 53 projecting on the lens barrel fixing ring 5. A head of the unlocking button 11 penetrates through the circular hole 54.

An O-ring 44 is interposed between the lens barrel fixing ring 5 and the first plate 13.

As shown in FIG. 17, according to the locking/unlocking mechanism 7, there is a possibility that water enters from a gap between the unlocking button 11 and the cabinet front portion 12 but the packing 40 and the O-ring 43 prevent water from entering the camera body 1.

In the locking/unlocking mechanism 7, if only the lens barrel lock pin 72 is pushed toward the camera body 1, only the first movable member 71 retracts and the case lock pin 74 does not retract at the same time. If only the case lock pin 74 is pushed toward the camera body 1, only the second movable member 73 retracts and the lens barrel lock pin 72 does not retract at the same time.

If the unlocking button 11 is pressed down, the first movable member 71 and the second movable member 73 are pressed down, and according to this motion, the lens barrel lock pin 72 and the case lock pin 74 retract at the same time.

In this camera, to attach the lens barrel 2 to the camera body 1, if the lens barrel 2 is pressed against the lens barrel fixing ring 5 of the camera body 1 in a predetermined relative angle attitude, the lens barrel lock pin 72 is pressed down and retracted by the lens barrel 2.

In this state, if the lens barrel 2 is rotated about 30° in the counterclockwise direction and is screwed into the lens barrel fixing ring 5, the lens barrel 2 is connected to the camera body 1. At this point, the lens barrel lock pin 72 of the camera body 1 is opposed to the pin hole 27 of the lens barrel 2, and the lens barrel lock pin 72 is biased by the spring 83 and fitted into the pin hole 27.

As a result, rotation of the lens barrel 2 is restrained and the lens barrel 2 is locked on the camera body 1.

Thereafter, to attach the waterproof case 3 to the camera body 1, if the waterproof case 3 is pressed against the case fixing ring 6 of the camera body 1 in a predetermined relative angle attitude, the case lock pin 74 is pressed down and retracted by the waterproof case 3. At that time, since the lens barrel lock pin 72 does not retract at the same time, the locked state of the lens barrel 2 is not released.

In this state, if the waterproof case 3 is rotated about 30° in the clockwise direction and screwed into the case fixing ring 6, the waterproof case 3 is connected to the camera body 1. At this point, the case lock pin 74 of the camera body 1 is opposed to the pin hole 38 of the waterproof case 3, and the case lock pin 74 is biased by the spring 82 and fitted into the pin hole 38.

As a result, the waterproof case 3 is locked on the camera body 1.

Even if the lens barrel 2 receives a clockwise rotation torque when the waterproof case 3 rotates, since the lens barrel 2 is locked, the screwed lens barrel 2 does not loosen.

By attaching the lens barrel 2 and the waterproof case 3 to the camera body 1 in this manner, the lens barrel 2 is accommodated in the case body 39 of the waterproof case 3 as shown in FIG. 7.

The engaging surface 37 provided on the inner peripheral surface of the rotating cylindrical member 32 of the waterproof case 3 is brought into contact with the outer peripheral surface 26 of the zoom ring 23 of the lens barrel 2 under pressure.

In this state, if a finger is put on the rotating cylindrical member 32 of the waterproof case 3 and the rotating cylindrical member 32 is rotated around the cylindrical shaft, the zoom ring 23 rotates integrally with the rotating cylindrical member 32, this rotation reciprocates the movable lens barrel portion 22 of the lens barrel 2 with respect to the fixed lens barrel portion 21 in the cylindrical shaft direction, and the zoom adjustment is carried out.

Since the transparent plate 30 is adhered and fixed to a front open end of the rotating cylindrical member 32, water does not enter from between the rotating cylindrical member 32 and the transparent plate 30. The first seal portion using the O-ring 4 waterproofs the bonding portion between the lens barrel 2 and the camera body 1, and the second seal portion using the O-ring 41 waterproofs between the fixed cylindrical member 31 and the rotating cylindrical member 32 of the lens barrel 2. A space between the rotating cylindrical member 32 and the movable cylindrical member 9 is waterproofed by the third seal portion using the ring-shaped seal member 45.

Therefore, even if the lens barrel 2 is a general lens barrel having no waterproof structure, if the waterproof case 3 is attached, it is possible to waterproof the bonding portion between the lens barrel 2 and the camera body 1 of the lens barrel 2.

By rotating the rotating cylindrical member 32 of the waterproof case 3, the zoom ring 23 of the lens barrel 2 can be rotated through the same angle as the rotation angle of the rotating cylindrical member 32. Therefore, the zoom adjustment becomes easy.

When the waterproof case 3 is to be detached, the unlocking button 11 is pressed down. According to this movement, the lens barrel lock pin 72 and the case lock pin 74 of the camera body 1 retract at the same time, these pins are pulled out from the pin hole 27 of the lens barrel 2 and the pin hole 38 of the waterproof case 3, the locked states of the lens barrel 2 and the waterproof case 3 are released, and the lens barrel 2 and the waterproof case 3 are allowed to rotate.

In this state, by rotating the fixed cylindrical member 31 of the waterproof case 3 abut 30° in the counterclockwise direction, the connection between the waterproof case 3 and the camera body 1 is released and they can be detached from each other. At that time, even if the lens barrel 2 receives a counterclockwise rotation torque when the waterproof case 3 rotates, the screwed lens barrel 2 does not loosen.

Thereafter, when the lens barrel 2 is to be detached from the camera body 1, the fixed lens barrel portion 21 of the lens barrel 2 is rotated about 30° in the clockwise direction while pressing down the unlocking button 11 of the camera body 1. According to this operation, the lens barrel 2 can be detached.

According to this camera, as shown in FIGS. 7 and 8, it is possible to design such that lengths of the waterproof case 3 in the retracted state and the projected state in the direction of the cylindrical shaft become slightly greater than lengths of the lens barrel 2 in the retracted state and the projected state in the direction of the cylindrical shaft. According to this design avoids a case where the inner peripheral surface of the movable cylindrical member 9 is included in an angle of view at the time of a shooting operation in a state where the waterproof case 3 is attached, especially at the time of a shooting operation in a state (retracted state) where the movable lens barrel portion 22 of the lens barrel 2 is retracted.

Further, at the time of a normal shooting operation requiring no waterproof, the locked state of the waterproof case 3 is released by operating the unlocking button 11 and the waterproof case 3 can be detached. Therefore, the troublesome operation is unnecessary.

The locked state of the waterproof case 3 and the locked state of the lens barrel 2 are released by means of the common unlocking button 11. Therefore, the number of the unlocking buttons is reduced as compared with a case where the unlocking buttons are prepared for the waterproof case 3 and the lens barrel 2, and the configuration of the locking/unlocking mechanism 7 becomes simple.

Incidentally, the configuration of each of the constituent parts according to the present invention is not limited to those described preferred embodiment. Various changes can be made by those skilled in the art within the range not departing from the spirit of the present invention.

For example, the configuration for rotating the zoom ring 23 of the lens barrel 2 integrally with the rotating cylindrical member 32 of the waterproof case 3 is not limited to the pressure contact structure between the outer peripheral surface 26 of the zoom ring 23 and the engaging surface 37 of the ring member 33 of the waterproof case 3, and it is possible to employ various engaging structures such as a fitting structure of convex and concave portions, and a meshing structure of tooth surfaces.

What is claimed is:

1. A waterproof case used for a camera in which a lens barrel including a zoom ring for a zoom operation is detachably attached to a camera body, the waterproof case comprising:
a cylindrical case body in which the lens barrel attached to the camera body is accommodated,
wherein, the case body includes:
a fixed cylindrical member which is detachably attached to the camera body,
a rotating cylindrical member which is relatively rotatably connected to a front opening of the fixed cylindrical member coaxially with the fixed cylindrical member,
a movable cylindrical member which is accommodated in the rotating cylindrical member and which is disposed such that the movable cylindrical member reciprocates along a cylindrical shaft of the rotating cylindrical member,
a transparent plate which closes a front opening of the movable cylindrical member,
an annular first seal portion, which surrounds a cylindrical shaft of the case body, which is provided on a bonding portion of the fixed cylindrical member with respect to the camera body,
an annular second seal portion, which surrounds the cylindrical shaft of the case body, which is provided on a bonding portion of the fixed cylindrical member with respect to the rotating cylindrical member,
an annular third seal portion, which surrounds the cylindrical shaft of the case body, which is provided on a bonding portion between the rotating cylindrical member and the movable cylindrical member,
an engaging surface, which comes into contact with an outer peripheral surface of the zoom ring of the lens barrel and which rotates the zoom ring integrally with the rotating cylindrical member, which is provided on an inner peripheral surface of the rotating cylindrical member, and
a converting mechanism, which converts rotation of the rotating cylindrical member into a reciprocating movement of the movable cylindrical member, which is interposed between the rotating cylindrical member and the movable cylindrical member.

2. The waterproof case for a camera according to claim 1, wherein the converting mechanism is a cam mechanism.

3. The waterproof structure for a camera according to claim 1, wherein the engaging surface is brought into contact with an outer peripheral surface of the zoom ring of the lens barrel under pressure.

4. The waterproof structure for a camera according to claim 2, wherein the engaging surface is brought into contact with an outer peripheral surface of the zoom ring of the lens barrel under pressure.

5. The waterproof case for a camera according to claim 1, wherein,
the first seal portion includes an O-ring which is to be sandwiched between the fixed cylindrical member and the camera body under pressure,
the second seal portion includes an O-ring which is to be sandwiched between the fixed cylindrical member and the rotating cylindrical member under pressure, and
the third seal portion includes a ring-shaped seal member having an outer periphery connected to the rotating cylindrical member and an inner periphery on which a tongue portion is formed, the tongue portion is in slide-contact with an outer peripheral surface of the movable cylindrical member.

6. The waterproof case for a camera according to claim 1, wherein
the first seal portion includes an O-ring which is to be sandwiched between the fixed cylindrical member and the camera body under pressure,
the second seal portion includes an O-ring which is to be sandwiched between the fixed cylindrical member and the rotating cylindrical member under pressure, and
the third seal portion includes a ring-shaped seal member having an outer periphery connected to the rotating cylindrical member and an inner periphery on which a tongue portion is formed, the tongue portion is in slide-contact with an outer peripheral surface of the movable cylindrical member.

7. The waterproof case for a camera according to claim 1, wherein
the first seal portion includes an O-ring which is to be sandwiched between the fixed cylindrical member and the camera body under pressure,
the second seal portion includes an O-ring which is to be sandwiched between the fixed cylindrical member and the rotating cylindrical member under pressure, and
the third seal portion includes a ring-shaped seal member having an outer periphery connected to the rotating cylindrical member and an inner periphery on which a tongue portion is formed, the tongue portion is in slide-contact with an outer peripheral surface of the movable cylindrical member.

8. The waterproof case for a camera according to claim 1, wherein
the first seal portion includes an O-ring which is to be sandwiched between the fixed cylindrical member and the camera body under pressure,
the second seal portion includes an O-ring which is to be sandwiched between the fixed cylindrical member and the rotating cylindrical member under pressure, and
the third seal portion includes a ring-shaped seal member having an outer periphery connected to the rotating cylindrical member and an inner periphery on which a tongue portion is formed, the tongue portion is in slide-contact with an outer peripheral surface of the movable cylindrical member.

9. A waterproof structure of a camera comprising:
a camera body;
a lens barrel which is detachably attached to the camera body and which includes a zoom ring for a zoom operation; and
a waterproof case which is detachably attached to the camera body coaxially with the lens barrel and which includes a cylindrical case body in which the lens barrel is accommodated, wherein
the case body includes:
a fixed cylindrical member which is detachably attached to the camera body,
a rotating cylindrical member which is relatively rotatably connected to a front opening of the fixed cylindrical member coaxially with the fixed cylindrical member,
a movable cylindrical member which is accommodated in the rotating cylindrical member and which is disposed such that the movable cylindrical member reciprocates along a cylindrical shaft of the rotating cylindrical member,
a transparent plate which closes a front opening of the movable cylindrical member,
an annular first seal portion, which surrounds a cylindrical shaft of the case body, which is provided on a bonding portion of the fixed cylindrical member with respect to the camera body,
an annular second seal portion, which surrounds the cylindrical shaft of the case body, which is provided on a bonding portion of the fixed cylindrical member with respect to the rotating cylindrical member,
an annular third seal portion, which surrounds the cylindrical shaft of the case body, which is provided on a bonding portion between the rotating cylindrical member and the movable cylindrical member,
an engaging surface, which comes into contact with an outer peripheral surface of the zoom ring of the lens barrel and which rotates the zoom ring integrally with the rotating cylindrical member, which is provided on an inner peripheral surface of the rotating cylindrical member, and
a converting mechanism, which converts rotation of the rotating cylindrical member into a reciprocating movement of the movable cylindrical member, which is interposed between the rotating cylindrical member and the movable cylindrical member.

10. The waterproof structure for a camera according to claim 9, wherein the converting mechanism is a cam mechanism.

11. The waterproof structure for a camera according to claim 9, wherein the cam mechanism includes a first cam curve which is to function as the fixed cylindrical member rotates when the waterproof case is attached to the camera body, and a second cam curve which is to function as the rotating cylindrical member of the waterproof case rotates in a state where the waterproof case is attached to the camera body, wherein,
the first cam curve is determined such that the movable cylindrical member is not moved by rotation of the rotating cylindrical member, and
the second cam curve is determined such that the movable cylindrical member is moved by rotation of the rotating cylindrical member.

12. The waterproof structure for a camera according to claim 9, wherein the engaging surface is brought into contact with an outer peripheral surface of the zoom ring of the lens barrel under pressure.

13. The waterproof structure for a camera according to claim 9, wherein
the first seal portion includes an O-ring which is to be sandwiched between the fixed cylindrical member and the camera body under pressure,
the second seal portion includes an O-ring which is to be sandwiched between the fixed cylindrical member and the rotating cylindrical member under pressure, and
the third seal portion includes a ring-shaped seal member having an outer periphery connected to the rotating cylindrical member and an inner periphery on which a tongue portion is formed, the tongue portion is in slide-contact with an outer peripheral surface of the movable cylindrical member.

14. The waterproof structure for a camera according to claim 9, wherein the lens barrel includes a fixed lens barrel portion which is to detachably be attached to the camera body, and a movable lens barrel portion which is disposed coaxially with the fixed lens barrel portion and which reciprocates along a cylindrical shaft of the fixed lens barrel portion, the zoom ring is disposed coaxially with the fixed lens barrel portion, and the movable lens barrel portion reciprocates in tandem with rotation of the zoom ring.
